(19) United States
(12) Patent Application Publication
(10) Pub. No.: US 2026/0275935 A1
(43) Pub. Date: Sep. 17, 2026

(54) SYSTEM FOR ACTUATION OF A THRUST REVERSER UNIT OF A JET ENGINE OF AN AIRCRAFT

(71) Applicant: AIRBUS OPERATIONS SAS, Toulouse (FR)

(72) Inventor: Aubry LEROY, Toulouse (FR)

(73) Assignee: AIRBUS OPERATIONS SAS, Toulouse (FR)

(21) Appl. No.: 19/569,679

(22) Filed: Mar. 17, 2026

(30) Foreign Application Priority Data
Mar. 17, 2025 (FR) 2502651

(51) Int. Cl. F02K 1/62

(52) U.S. Cl. CPC F02K 1/62

(57) ABSTRACT

A system for actuation of a thrust reverser unit of a jet engine of an aircraft. The actuation system includes one actuator associated with (at least) one electric motor to set the thrust reverser unit in motion from a stowed position to a deployed position (in an extension phase) or vice versa (in a retraction phase). The electric motor is of the dissipative type and configured to dissipate at least part of the energy generated thereby when it counterbalances a tensile load to which the actuation system is subjected during the extension phase. The use of a dissipative electric motor makes it possible to require neither a resistor bank nor mechanical energy dissipation means, and therefore to preserve the reliability of the electronics for controlling the electric motor while at the same time limiting the cost, weight and bulk of the actuation system.

### TECHNICAL FIELD

The field of the invention is that of thrust reversers, also called thrust reverser units (TRUs), for jet engines (also called turbojets) of aircraft.

More precisely, the present invention relates to a system for actuation of a thrust reverser unit (TRU) of a jet engine of an aircraft. Such an actuation system is also called a thrust reverser actuation system (TRAS).

### PRIOR ART

The thrust reverser of an aircraft jet engine is a device that makes it possible, by interposing an obstacle (i.e. by deploying a blocking element) in an outlet jet of the jet engine, to deflect this jet forwards in order to slow down the aircraft (by providing additional braking) and thus to not act excessively on the brakes of the wheels and to reduce the braking distance during landing.

The thrust reverser is, for example, integrated in a nacelle (also known as engine pod), which is an element with a tapered shape, constituted of a structure specially designed to contain the engine and its frame, and, for certain types of aircraft, the landing gear. To this structure, for example, are fastened the air inlet fairing on the front, cowls on the sides and the thrust reverser at the rear.

In a first particular configuration, the actuation system (TRAS) comprises a single actuator associated with (i.e. actuated by) a single electric motor, to set the thrust reverser unit (TRU), and more precisely the blocking element, in motion from a stowed (folded) position to a deployed position, in an extension phase, or from the deployed position to the stowed position, in a retraction phase.

Other configurations are also possible:
a single electric motor actuates a plurality of actuators;
a plurality of electric motors, each actuating a single actuator; and
a plurality of electric motors, each actuating a plurality of actuators.

Purely for the sake of simplification, the discussion that follows is presented considering the first abovementioned configuration (a single electric motor actuates a single actuator). However, this discussion can easily be transposed to the other configurations listed above.

During the deployment of the thrust reverser unit, the actuator is deployed under the effect of a tensile load (see the description of FIG. 4 below). This means that the electric motor operates in the “generator” quadrant, and therefore generates energy. In other words, the electric motor generates energy when it counterbalances the tensile load to which the actuation system is subjected during the extension phase.

It is preferable that this generated energy be dissipated rather than injected into the electrical network of the aircraft, so as not to disturb the latter and the equipment that is connected thereto.

A first known technique, for dissipating the energy generated by the electric motor during the deployment of the thrust reverser unit, consists in realizing electrical dissipation, using resistive elements (a resistor bank, for example) contained in electronic circuitry for controlling the electric motor. A drawback of this first known technique is that the resistor bank constitutes an additional cost, weight and bulk. Furthermore, the resistor bank constitutes a constraint for the electronics because it converts the energy into heat, and this tends to degrade the reliability of the electronics.

A second known technique, for dissipating the energy generated by the electric motor during the deployment of the thrust reverser unit, consists in using mechanical energy dissipation means. A drawback of this second known technique is that the mechanical energy dissipation means constitute an additional cost, weight and bulk.

The abovementioned first and second known solutions are satisfactory, but there is a need to improve them further, in particular by preserving the reliability of the electronics for controlling the electric motor (for the first technique) and by not requiring means (whether a resistor bank or mechanical energy dissipation means) constituting an additional cost, weight and bulk.

### SUMMARY OF THE INVENTION

There is proposed a system for actuation of a thrust reverser unit of a jet engine of an aircraft, the actuation system comprising at least one actuator associated with at least one electric motor to set the thrust reverser unit in motion from a stowed position to a deployed position, in an extension phase, or from the deployed position to the stowed position, in a retraction phase. Said at least one electric motor is of the dissipative type and configured to dissipate at least part of the energy E generated by said at least one electric motor when said at least one electric motor counterbalances a tensile load to which the actuation system is subjected during the extension phase.

Thus, the use of at least one dissipative electric motor makes it possible to dissipate at least part of the energy generated by said at least one electric motor during the deployment of the thrust reverser unit. This makes it possible to require neither a resistor bank nor mechanical energy dissipation means, and therefore to preserve the reliability of the electronics for controlling said at least one electric motor while at the same time limiting the cost, weight and bulk of the system (TRAS) for actuation of the thrust reverser unit (TRU).

According to one particular embodiment, said at least one dissipative electric motor is configured to dissipate at least 10% of the energy E.

According to one particular embodiment, said at least one dissipative electric motor comprises a stator core that is solid and non-laminated.

According to one particular embodiment, said at least one dissipative electric motor comprises a stator core that is laminated and that comprises at most N thick laminations each having a thickness greater than or equal to Tₘᵢₙ, with N∈[1, 100] and Tₘᵢₙ=2 mm.

According to one particular embodiment, the system comprises a mechanical stop dimensioned to absorb an impact with said at least one actuator, and thus mechanically dissipate residual energy from said at least one actuator, when said at least one actuator is at the end of travel of the extension phase and has a residual speed after said at least one dissipative electric motor has dissipated at least part of the energy E.

According to one particular embodiment, the actuation system comprises electronic circuitry for controlling said at least one electric motor, itself comprising at least one resistive element configured to electrically dissipate residual energy from said at least one actuator, when said at least one actuator is at the end of travel of the extension phase and has a residual speed after said at least one dissipative electric motor has dissipated at least part of the energy E.

According to one particular embodiment, the actuation system comprises electronic circuitry for controlling said at least one electric motor, configured to transfer residual energy from said at least one actuator to an electrical network of the aircraft, when said at least one actuator is at the end of travel of the extension phase and has a residual speed after said at least one dissipative electric motor has dissipated at least part of the energy E.

There is also proposed an aircraft comprising an actuation system as mentioned above, in any one of its embodiments.

### BRIEF DESCRIPTION OF THE DRAWINGS

The abovementioned features of the invention, along with others, will become more clearly apparent upon reading the following description of at least one exemplary embodiment, said description being given with reference to the appended drawings, in which:

FIG. 1 schematically illustrates, in perspective, an aircraft equipped with nacelles each integrating a jet engine and a system for actuation of a thrust reverser unit according to the invention;

FIG. 2 schematically illustrates a system for actuation of a thrust reverser unit, in one embodiment;

FIG. 3 schematically illustrates a thrust reverser unit in the stowed position;

FIG. 4 schematically illustrates a thrust reverser unit in the deployed position;

FIG. 5 illustrates curves of distribution of the load of an actuation system as a function of its travel, corresponding to different cases (extension phase with an actuation system that is conventional or according to the invention, and retraction phase with an actuation system that is conventional or according to the invention); and

FIG. 6 schematically illustrates an exemplary hardware architecture of the electronic circuitry for controlling the electric motor, appearing in FIG. 2.

### DETAILED DESCRIPTION OF EMBODIMENTS

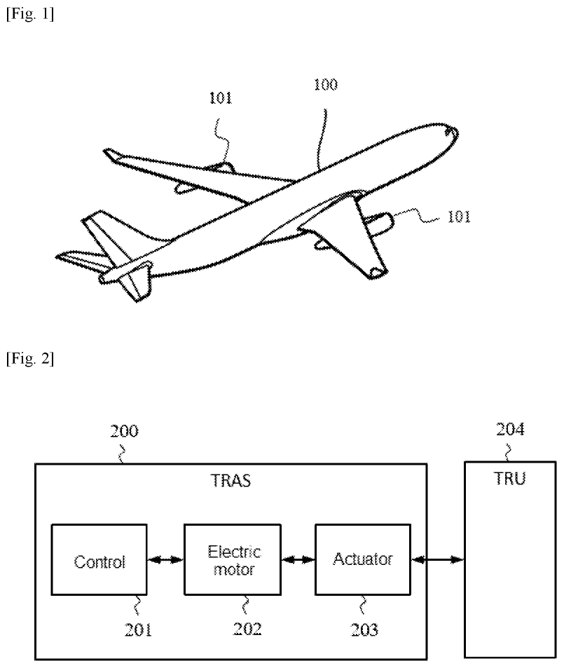

FIG. 1 schematically illustrates, in perspective, an aircraft 100 equipped with two nacelles (also known as pods) 101 (one beneath each wing) each integrating a jet engine (turbojet) and a system (TRAS) for actuation of a thrust reverser unit (TRU) according to the invention. In variants, the aircraft may comprise a different number of nacelles.

FIG. 2 schematically illustrates a system 200 (TRAS) for actuation of a thrust reverser unit 204 (TRU), in a basic configuration. In this basic configuration, the actuation system 200 comprises an actuator 203, an electric motor 202 and electronic circuitry 201 for controlling the electric motor. The actuator 203 is driven (actuated) by the electric motor 202, under the control of the electronic circuitry 201, to set the thrust reverser unit 204 in motion from a stowed position to a deployed position, in an extension phase, or from the deployed position to the stowed position, in a retraction phase.

The present invention is not limited to this basic configuration (in which a single electric motor actuates a single actuator) but also applies to the following other configurations:
a single electric motor actuates a plurality of actuators;
a plurality of electric motors, each actuating a single actuator; and
a plurality of electric motors, each actuating a plurality of actuators.

Purely for the sake of simplification, only the basic configuration is considered in the remainder of the description. As already mentioned above, the present invention is not limited to the latter and also applies to the other abovementioned configurations.

FIG. 6 schematically illustrates an exemplary hardware architecture of the electronic circuitry 201 for controlling the electric motor, which then comprises, connected by a communication bus 610: a processor or CPU (central processing unit) 601; a random access memory (RAM) 602; a read-only memory (ROM) 603, for example a flash memory; a data storage device, such as a hard disk drive (HDD), or a storage medium reader, such as an SD (Secure Digital) card reader 604; and at least one communication interface 605. The processor 601 is capable of executing instructions that form a computer program and that are loaded into the RAM 602 from the ROM 603, from an external memory (not shown), from another storage medium (such as an SD card), or from a communication network (not shown). When the electronic circuitry 201 is powered up, the processor 601 is capable of reading the abovementioned instructions from the RAM 602 and executing them. When they are read (from the RAM 602 or a storage medium) and executed by the processor 601, these instructions (which form a computer program) cause the processor 601 to execute the behaviours, steps and algorithm described here. All or some of the behaviours, steps and algorithm described here may thus be implemented in software form by executing a set of instructions using a programmable machine, such as a DSP (digital signal processor) or a microcontroller, or be implemented in hardware form by a machine or a dedicated component (chip) or a dedicated set of components (chipset), such as an FPGA (field-programmable gate array) or ASIC (application-specific integrated circuit). An electronic device, such as an inverter, may be added to transform the control signal generated by the electronic circuitry 201 into an electrical signal that is compatible with the electric motor.

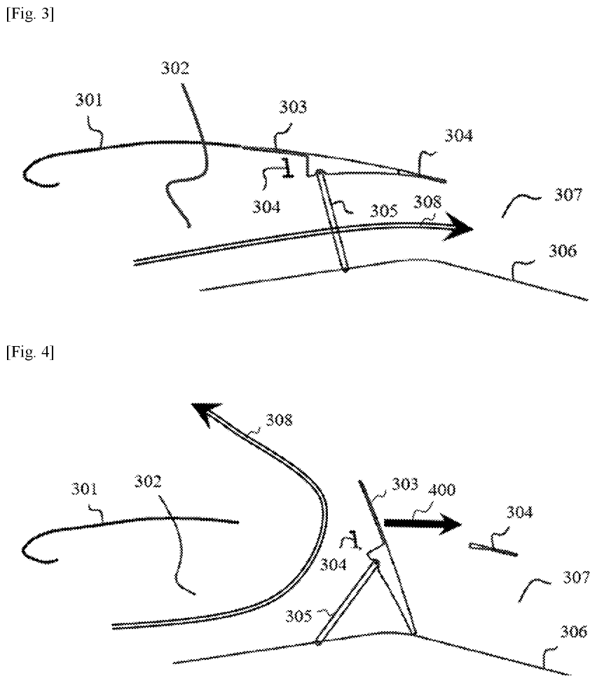

FIG. 3 schematically illustrates the thrust reverser unit 204, in a particular implementation, in the stowed position. It is assumed that the thrust reverser unit is integrated in a nacelle having a cowl comprising a fixed cowl part 301 and a mobile cowl part 304 (forming a sliding sleeve) that is able to move in translation along a longitudinal axis of the nacelle. It is also assumed that a turbofan jet engine (turbojet) (not shown) is disposed in the internal volume of the nacelle, which is delimited by the cowl. The thrust reverser unit is of the “sliding sleeve” (or “translating cowl”) type and comprises: the mobile cowl part (forming a sliding sleeve 304), the fixed cowl part 301, an external wall 306 of the jet engine (which can be realized by an internal cowl surrounding the jet engine), a blocking door (pivoting door) 303 and a connecting member (arm) 305 (having a first end mounted via a pivot connection on the external wall 306 of the jet engine and a second end to which the blocking door 303 is fastened). In the stowed position illustrated in FIG. 3, the secondary air flow (symbolized by the arrow referenced 308) is direct. It passes through the nacelle from the front to the rear, with the blocking door 303 stowed and extending in the continuation of the walls of the fixed 301 and mobile 304 cowl parts of the nacelle, such that the air flow 308 travels via a passage channel 302 and exits only via the rear 307 of the nacelle, and this generates a thrust force directed forwards. Only the connecting arm 305 is in the air flow 308.

FIG. 4 schematically illustrates the thrust reverser unit 204, in the same particular implementation as in FIG. 3, but in the deployed position. In this deployed position, the air flow (still symbolized by the arrow referenced 308) is reversed. The mobile cowl part (sliding sleeve) 304 is pushed backwards by the actuation system 200 (TRAS), thus making it possible to deploy the blocking door 303 (the connecting arm 305 pivots by virtue of the pivot connection with the external wall 306 of the jet engine). Consequently, the air flow 308 is blocked by the blocking door 303 and redirected towards the front, and this generates a thrust force directed towards the rear (also called “counterthrust”) that is added to the braking of the wheels of the aircraft. The actuation system 200 (TRAS) is subjected to a tensile load (symbolized by the arrow referenced 400). This load is counterbalanced by the electric motor, for example with the aid of gears and/or ball or roller screw mechanisms.

The thrust reverser unit 204 (TRU), like the system 200 (TRAS) that makes it possible to actuate it, operates in a binary manner:
in an extension phase, it passes from the stowed position to the deployed position; and
in a retraction phase, it passes from the deployed position to the stowed position.

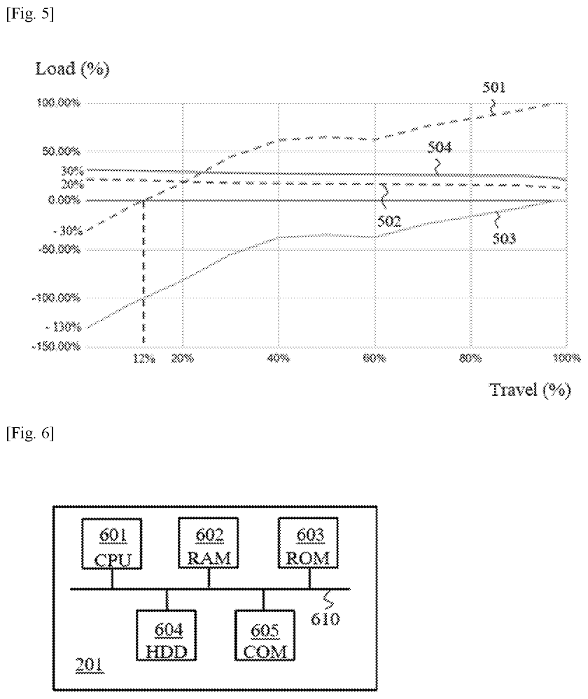

FIG. 5 illustrates various curves of distribution of the load of an actuation system as a function of its travel, corresponding to various cases. First, the following two curves are of interest:
the curve referenced 501, corresponding to the case of an extension phase with a conventional actuation system (TRAS); and
the curve referenced 502, corresponding to the case of a retraction phase with a conventional actuation system (TRAS).

These curves are not intended to be an exact reflection of reality, but aim only to illustrate the way in which the evolution of the load as a function of the travel is affected. For example, the following hypotheses are considered: the speed is considered to be constant over the entire travel; the efficiency of the mechanical system is 100%; the MIN/MAX envelope is not taken into account; and the deceleration capacity is not taken into account.

It is assumed, for example, that, during the extension phase, the rotational speed of the motor is positive, constant and equal to 8000 rpm. In this case, when the load is positive, the electric motor operates in the “generator” quadrant (and therefore generates energy that has to be dissipated); and when the load is negative, the electric motor operates in the “motor” quadrant (no generation of energy to be dissipated).

It can be seen in curve 501 that, during the extension phase, the electric motor starts in the “motor” quadrant (load equal to −30% of the maximum load for 0% of the travel), then moves into the “generator” quadrant (from 0% of the maximum load (for 12% of the travel) to 100% of the maximum load (for 100% of the travel), which is the reference point).

Likewise, it is assumed, for example, that, during the retraction phase, the rotational speed of the motor is negative, constant and equal to 2500 rpm. In this case, when the load is negative, the electric motor operates in the “generator” quadrant (and therefore generates energy that has to be dissipated); and when the load is positive, the electric motor operates in the “motor” quadrant (no generation of energy to be dissipated).

It can be seen in curve 502 that, during the retraction phase, the electric motor is always in the “motor” quadrant (load equal to 20% of the maximum load, for the entire travel (0 to 100%)).

In summary, with a conventional actuation system (TRAS), it is only during part of the extension phase (i.e. when the load is positive; for the portion of travel between 12% and 100% in the example of curve 501) that the electric motor operates in the “generator” quadrant, and therefore generates energy that has to be dissipated (rather than injecting it into the electrical network of the aircraft).

In order to solve this technical problem, the general principle of the present invention consists in using an electric motor 202 of the dissipative type and configured to dissipate at least part of the energy E that it generates when it counterbalances the tensile load to which the actuation system 200 (TRAS) is subjected during the extension phase. In a particular implementation, the dissipative electric motor 202 is configured to dissipate at least 10% of the energy E. Approaching 100% of energy dissipated directly in the dissipative electric motor makes it possible to limit the use of complementary means (for example those described below) to dissipate the residual energy (i.e. the energy not dissipated by the dissipative electric motor), and in particular to prevent the energy generated by the electric motor from being injected into the electrical network of the aircraft.

FIG. 5 also illustrates the following two curves:
the curve referenced 503, corresponding to the case of an extension phase with an actuation system (TRAS) according to the invention; and
the curve referenced 504, corresponding to the case of a retraction phase with an actuation system (TRAS) according to the invention.

It can be seen in curve 503 that, during the extension phase, the electric motor is always in the “motor” quadrant (from −130% of the maximum load for 0% of the travel to 0% of the maximum load for 100% of the travel). Thus, in this example, the electric motor does not generate energy that has to be dissipated (the energy is dissipated by the electric motor itself).

In terms of absolute value, the offset between curves 501 (without the invention) and 503 (with the invention) is equal to 100%.

It can be seen in curve 504 that, during the retraction phase, the electric motor is always in the “motor” quadrant (load equal to 30% of the maximum load, for the entire travel (0 to 100%)). In terms of absolute value, the offset between curves 502 (without the invention) and 504 (with the invention) is only 10%.

In a first embodiment, in order to give it the desired dissipative character, the electric motor 202 comprises a stator core that is solid and non-laminated, and that will therefore generate eddy currents that make it possible to dissipate energy. More precisely, the eddy currents in such a stator core dissipate the energy according to the following equation:

$$P e = \frac{2 \cdot {B}^{2} \cdot {t}^{2} \cdot {f}^{2}}{ρ β} ,$$

where:
Pe is the power dissipated per unit mass in the stator core (W/kg);
t is the thickness of the material, in this case the thickness of the solid and non-laminated stator core;
B is the maximum amplitude of the magnetic field (T);
ρ is the resistivity of the material (Ω m);
β is a coefficient linked to the geometric structure; and
f the frequency of variation of the magnetic field (this frequency f is linked to the speed of the motor).

It is recalled that, usually, the stator core of an electric motor is not solid but is laminated (with several tens, or even several hundreds, of sheets), in order to reduce the eddy currents as much as possible (normally around 0.1 to 0.2% of the nominal power of an electric machine), as these typically cause a loss of power and degradation of the performance.

On the contrary, and counter-intuitively because this results in an electric motor with lower performance, the present invention uses the eddy currents to dissipate energy. Since the power thus dissipated Pe is proportional to t² (where t is the thickness of the material), the quantity of energy dissipated can be high.

When the actuator reaches the end of its travel during the extension phase (i.e. approaches 100% of the travel), the load of the actuation system is at a maximum (see curve 501 in FIG. 5) and the actuator has to be stopped. Now, when the speed of the electric motor is close to zero, the dissipation of energy by the dissipative electric motor is almost zero. Specifically, the eddy currents, and therefore the dissipated power, are proportional to f², and therefore also to the square of the speed of the electric motor (since the frequency f is linked to this speed).

In one embodiment, one or more of the following complementary solutions are implemented to dissipate residual energy from the actuator, when the actuator is at the end of travel of the extension phase and has a residual speed (after the dissipative electric motor has dissipated at least part of the energy that it generates when it counterbalances the tensile load to which the actuation system is subjected during the extension phase):
a mechanical stop is dimensioned to absorb an impact with the actuator, and thus mechanically dissipate at least part of the abovementioned residual energy;
the electronic circuitry 201 for controlling the electric motor comprises at least one resistive element configured to electrically dissipate at least part of the abovementioned residual energy; and
the electronic circuitry 201 for controlling the electric motor is configured to transfer at least part of the abovementioned residual energy to the electrical network of the aircraft.

In a second embodiment (variant corresponding to an intermediate configuration between the conventional laminated stator core and the solid, non-laminated stator core of the first embodiment), in order to give it the desired dissipative character, the electric motor comprises a stator core that is laminated and that comprises at most N thick laminations each having a thickness greater than or equal to Tₘᵢₙ, with N∈[1, 100] and Tₘᵢₙ=2 mm.

1. A system for actuation of a thrust reverser unit of a jet engine of an aircraft, the actuation system comprising at least one actuator associated with at least one electric motor to set the thrust reverser unit in motion from a stowed position to a deployed position, in an extension phase, or from the deployed position to the stowed position, in a retraction phase, wherein at least one electric motor comprises a stator core belonging to a group comprising:
a stator core that is solid and non-laminated; and
a stator core that is laminated and that comprises N thick laminations each having a thickness greater than or equal to Tₘᵢₙ, with N∈[1, 100] and Tₘᵢₙ=2 mm;
said stator core giving the electric motor a dissipative character and being configured to dissipate at least part of the energy E generated by said at least one electric motor when said at least one electric motor counterbalances a tensile load to which the actuation system is subjected during the extension phase.

2. The actuation system according to claim 1, wherein said stator core is configured to dissipate at least 10% of the energy E.

3. The actuation system according to claim 1, comprising a mechanical stop dimensioned to absorb an impact with said at least one actuator, and thus mechanically dissipate residual energy from said at least one actuator, when said at least one actuator is at the end of travel of the extension phase and has a residual speed after said at least one electric motor (202) has dissipated at least part of the energy E.

4. The actuation system according to claim 1, comprising electronic circuitry for controlling said at least one electric motor, itself comprising at least one resistive element configured to electrically dissipate residual energy from said at least one actuator, when said at least one actuator is at the end of travel of the extension phase and has a residual speed after said at least one electric motor has dissipated at least part of the energy E.

5. The actuation system according to claim 1, comprising electronic circuitry for controlling said at least one electric motor, configured to transfer residual energy from said at least one actuator to an electrical network of the aircraft, when said at least one actuator is at the end of travel of the extension phase and has a residual speed after said at least one electric motor has dissipated at least part of the energy E.

6. An aircraft comprising a system, according to claim 1, for actuation of a thrust reverser unit of the aircraft.
